(19) United States
(12) Patent Application Publication
(10) Pub. No.: US 2005/0037730 A1
(43) Pub. Date: Feb. 17, 2005

(54) Mobile wireless phone with impact sensor, detects vehicle accidents/thefts, transmits medical exigency-automatically notifies authorities

(76) Inventor: Albert Montague, Brooklyn, NY (US)

Correspondence Address: ALBERT MONTAGUE, PH.D.,;P.E. MANAGER, SIVAN LLC, 100 OCEANA DR. WEST APT. 3I, BROOKLYN, NY, 11235, US

(21) Appl. No.: 10/915,819

(22) Filed: Aug. 11, 2004

Related U.S. Application Data
(60) Provisional application No. 60/494,367, filed on Aug. 12, 2003.

(51) Int. Cl. H04M 1/00; H04B 1/38

(52) U.S. Cl. 455/404.2; 455/456.1

(57) ABSTRACT

This invention relates to the use and proper placement in a vehicle of a mobile wireless phone having cellular or GPS positioning capability and an impact sensor, e.g. triaxial accelerometer. Said sensor instantly detects a serious vehicular accident or theft, then and without driver or passenger intervention, automatically transmits an emergency appeal for assistance to appropriate Police/Emergency Medical Services (PEMS), or Fire Rescue units, apprizing the PEMS of said exigency and location. Otherwise, the integrated mobile phone system will function in a manner that is similar to a conventional wireless mobile phone. Optionally, the integrated mobile wireless phone may include means for receiving an emergency medical signal and automatically communicates an appeal for emergency assistance when the user having said unit and having a predisposed life threatening medical condition, encounters a life threatening anomaly, e.g., heart attack. System provides means to mitigate multi-vehicle collisions that are normally associated with environmental road hazards fog, ice, etc., by instantly alerting authorities and/or drivers in the region of the location of said hazard when an accident occurs.

### RELATED APPLICATION

This application is based on provisional application Ser. No. 60/494,367 filed on Aug. 12, 2003.

### FIELD OF THE INVENTION

The present invention relates to the use and placement of a mobile wireless phone having a Global Positioning System and a built-in impact sensor, e.g., triaxial accelerometer, will when placed in the cradle of a mated stand automatically and instantly detect a vehicular accident or vehicle theft. The system will within seconds of an accident and without driver or passenger intervention automatically notify appropriate authorities, Police, Emergency Medical Services (PEMS) and/or Fire Rescue units and transmit the vehicles location, vehicle ID, and other important data, by analogue or digital means. Automatic notification can be directed to an organizational dispatcher or optionally to the closest PEMS vehicle(s) that is in the vicinity of the vehicle requesting immediate emergency assistance. Voiceless and direct communication to the nearest police or EMS cruiser—dispatcher free notification—is in the interest of time, the preferred communication approach. Optionally, an acknowledgment that PEMS assistance is in-route or has been dispatched is transmitted to the wireless mobile phone that transmitted the appeal for emergency assistance, taking the form of audio message, mechanical vibration or other means of notification. Said wireless mobile phone with its integrated impact sensor becomes operational as a motion (impact) detector only when it is placed in the cradle of a mated stationary stand that is in the vehicle. The stand is aligned, i.e., positioned longitudinally and transversely in the vehicle, and connected to the vehicles power supply, battery, in order to provide power to the both the mobile phone and impact sensor circuits. The mobile phone, once removed from the stand will operate in a similar to a conventional wireless phone, since the impact sensor circuit is no longer powered in conventional mobile phone use, e.g., walking.

Alternatively, the impact sensor, e.g., triaxial accelerometer with its attendant hardware and software could be housed in the mated stand previously described instead of the mobile phone providing proper longitudinal and transverse stand alignment with the vehicle is maintained. Detection of an anomaly in the vehicles motion, i.e., accident or theft, by the motion (impact) sensor would activate the mobile phone either by wire or wireless means.

This mobile phone system would because of the instant notification feature mitigate multi-vehicle collisions (MVC) that are normally associated with environmental road hazards due to roads covered by ice, snow or simply wet and slippery due low traces of hydrocarbons mixed in with the surface moisture or human error, by simply alerting drivers in the region of said hazard.

Optionally, the mobile wireless phone may also include an input jack or wireless means to receive a signal, e.g., triggering medical information or data associated with a personal life threatening situation and automatically transmit an appeal for assistance. The data would be generated by a body sensor or bio-garment that is worn by an individual with a predisposed medical condition. The sensor(s) would constantly monitor critical body functions and when a physiological anomaly is detected automatically activate the mobile phone and initiate the notification process. Said appeal for assistance would provide location information, ID, etc., without human intervention.

### STATE OF THE ART

U.S. Pat. No. 6,642,844 B2 to Montague, the disclosure of which is incorporated herein by reference states the following: “Vehicular accidents with their attendant injuries, losses of life and vehicular thefts as well as other non-vehicular social exigencies have an enormous social economic cost, currently estimated to be in the tens of billions of dollars each year. It is also common knowledge that many of these accidents, sustained injuries and other medical emergencies could be less severe, with many lives saved and not lost, if the emergency medical assistance sought arrived in a timely manner; in some instances just seconds earlier. In addition, property losses resulting from vehicular and non-vehicular thefts would also be substantially less, if requests for emergency assistance to the nearest available police cruiser are instantaneous, and the response equally prompt. There is no doubt that requests for life threatening emergency assistance and subsequent response by appropriate emergency assistance organizations should be sooner rather than later.”

Again, citing U.S. Pat. No. 6,642,844 B2 and U.S. Pat. No. 6,166,656 to Okada, et al. (“Okada”), the disclosure of which is incorporated herein by reference, notes with regard to current external transmissions and communication of an accident that “Probable prescribed addresses may include a district police station or fire station for notifying the occurrence of accident, and a rescue association if there is any damage to the vehicle.” Further, that “In many automobile accidents, life is in danger even while the emergency is being reported.” Okada's recommended solution in part is, “to ask for help from nearby persons by publicly announcing the occurrence of an accident as soon as possible, or to apply first-aid treatment to prolong life until the rescue squad arrives.” Okada, in this regard discloses, “An emergency assistance system for summoning first-aid assistance of persons and vehicles within the vicinity of a person involved in an automobile accident, while also making an emergency call to rescue and police authorities.” Okada also claims and provides for “estimating position of a vehicle,” “accident detection means . . . ,” and “external communication means for notifying an emergency response organization of accident related information.

“The aforementioned solution for vehicular emergencies fails to recognize that accidents often occur in remote regions where there are no persons or vehicles to witness, hear, or see the various alarms or receive local transmission signals generated by the suggested “small broadcasting equipment.” Even if nearby people were apprized of an accident they would not, with certainty, be qualified to administer first aid. Further, the possibility of being sued by the injured party for aggravating the persons' injury could preclude direct intervention by any third party that may arrive first at the accident scene. Finally, calling an emergency “organization” for assistance consumes precious time. The following scenario or steps are generally followed to secure emergency assistance from an emergency “organization.” First, a phone must be secured. This would be followed by an individual placing an emergency call to 911, then having to wait until a connection is established since 911 a well known emergency number may be busy. A verbal telephone link must then be established with a dispatcher, but now another delay may be encountered because the dispatcher is on another emergency call. Finally, when the dispatcher comes on line, information must then be conveyed about the accident, its location and other particulars. The dispatcher must then locate the nearest and available P/EMS and dispatch that vehicle(s) to the accident scene. This time consuming process wastes critical seconds, possibly minutes, as it runs through the aforementioned notification process, while a injured person(s) is (are) in need of immediate and proper medical attention. While many non-vehicular medical emergencies and thefts may forego the need to secure a wire or wireless telecommunications unit or system, e.g., phone or cell phone, the same aforementioned delays would be encountered when communicating with an organizational dispatcher. Time delays, even seconds, are critical when an injured person(s) is (are) in trauma and in urgent need of specialized and immediate medical attention.”

Nothing in the prior art and literature, advances the use and placement of a mobile wireless phone having global positioning technology and a built-in or satellite (mating stand) impact (motion) sensor, e.g., triaxial accelerometer, that will automatically and instantly detect a vehicular accident or vehicle theft and without human intervention notify appropriate authorities. Furthermore, the prior art and literature does not advance the use of a mobile phone, a wireless telecommunication system that also has the means and without human intervention, to automatically notify appropriate PEMS authorities and instantly seek medical assistance when a person is experiencing a life threatening medical problem, even when the individual is unconscious.

### SUMMARY AND OBJECTS OF THE INVENTION

The present invention overcomes the limitations of the prior art by providing a mobile wireless telecommunications system, i.e., phone with GPS technology having a built-in impact (motion) sensor, e.g., triaxial accelerometer, the latter capable of instantly and automatically detecting a vehicular, car, SUV, truck, motorbike, accident caused by an impact or theft. The mobile wireless phone with the integrated impact sensor once placed in the mated stand that is in the vehicle will within seconds of a severe impact and without driver or passenger intervention notify appropriate authorities, Police, Emergency Medical Services (PEMS) and/or Fire Rescue units of a said exigency and simultaneously convey its location using either analogue or digital signals, i.e., voice or voiceless communication. Automatic notification can be directed to an organizational dispatcher, or optionally, to the PEMS vehicle(s) that is nearest to the vehicle in need of immediate emergency assistance. Voiceless and direct communication to the nearest police or EMS cruiser—dispatcher free notification—is in the interest of time the preferred communication approach. The wireless mobile phone and motion sensor are operative for said use only when the phone (handset) is placed in the cradle (mating stand). The sensor whether it is integrated in the handset or alternately in the mating stand must be properly positioned in the vehicle, i.e., aligned, longitudinally and transversely with the vehicle. The system would operate as specified when the mobile phone handset is placed in the cradle (stand), the latter connected to the vehicle's power supply, battery. Otherwise, the mobile phone will function in a manner that is similar to a conventional wireless mobile phone. Again, it should be understood that the impact sensor could also be housed in the mating stand and the system would function as intended providing the mobile phone is placed in the cradle of the stationary stand that is electrically wired, i.e., connected to the vehicles electrical circuit, i.e., battery.

The integrated mobile wireless phone, which could be either carried or placed on a person, includes an input jack or wireless means for the purpose of automatically receiving a signal from a user's portable medical or triage apparatus, pacemaker, etc., and without user intervention automatically communicates an appeal for emergency medical assistance, when a life threatening situation is detected. This novel technology would because of the instant notification feature mitigate multi-vehicle collisions (MVC) that are normally associated with environmental road hazards due to roads covered by ice, snow or simply wet and slippery due low traces of hydrocarbons mixed in with the surface moisture or human error. Said hazard could instantly be transmitted to all vehicles in the region.

The ability to communicate directly with a P/EMS vehicle(s) hinges on the use of essentially flawless vehicle accident, theft and medical characterization technology. This approach eliminates the need for a dispatcher and the associated life threatening time delays when processing information, while providing exacting means to respond to the exigency in the shortest time frame that is technologically possible. It will also substantially reduce the notification time for the P/EMS vehicle(s) to be apprized of the exigency. This cost-effective approach will maximize the probability of saving lives, since seconds count when an injured person(s) is (are) experiencing possible trauma.

According to one feature the invention, means are provided to use a mobile phone and stand with a built-in impact (motion) sensor that can constantly monitor detect and characterize vehicle accidents and thefts, then automatically and instantly notify appropriate authorities without human intervention. It can be used by all vehicle owners. The present methodology eliminates the need and attendant critical time delays that are manifest when human dispatchers are involved in the processing and routing or P/EMS cruisers during a vehicular life or property threatening emergency. Accurate and timely routing of the nearest P/EMS cruiser to the scene of a life threatening vehicular accident or theft is accomplished by employing real-time, instantaneous, essentially flawless vehicle accident and theft characterization technology, that is electronically coupled to a modified vehicle-to-vehicle global positioning/fleet management and communication system thereby circumventing the need and attendant time delays that are associated with a human dispatcher.

Another feature of the invention is the ability to use the mobile phone by wire or wireless means to receive a signal, e.g., triggering medical information or data associated with a personal life threatening situation and automatically transmit an appeal for assistance. The data would be generated by a body sensor or bio-garment that is worn by an individual with a predisposed medical condition. The sensor(s) would constantly monitor critical body functions and when a physiological anomaly is detected automatically activate the mobile phone and initiate the notification process. Said appeal for assistance would provide location information, ID, etc., without human intervention.

According to another feature of the invention, this mobile phone system could provide instant notification of an accident that would mitigate multi-vehicle collisions by simply alerting drivers in the region of said hazard, e.g., fog.

### BRIEF DESCRIPTION OF THE DRAWINGS

FIG. 1 is a flow diagram of the system network for a vehicular theft, accident, medical emergency and

FIG. 2 is a flow diagram of CPU 20.

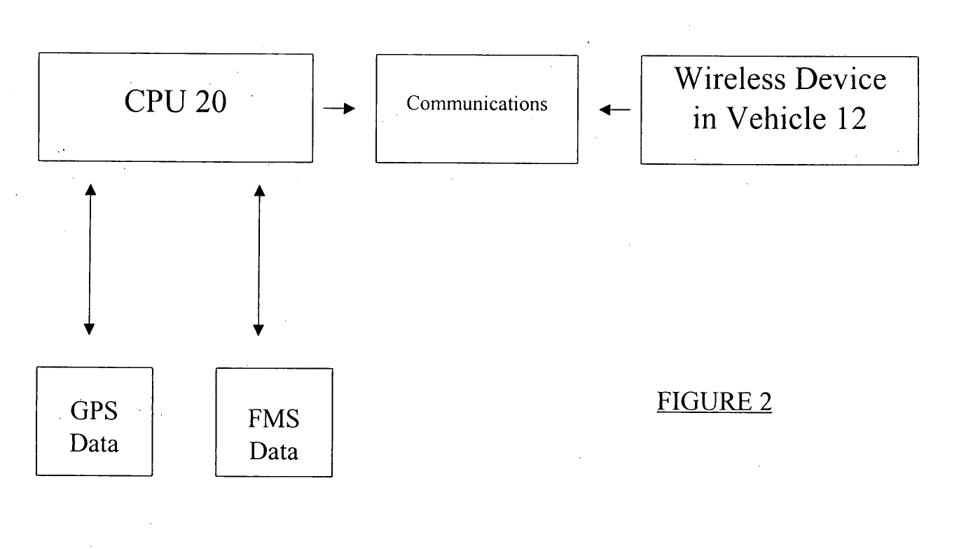

### DETAILED DESCRIPTION OF THE PREFERRED EMBODIMENTS

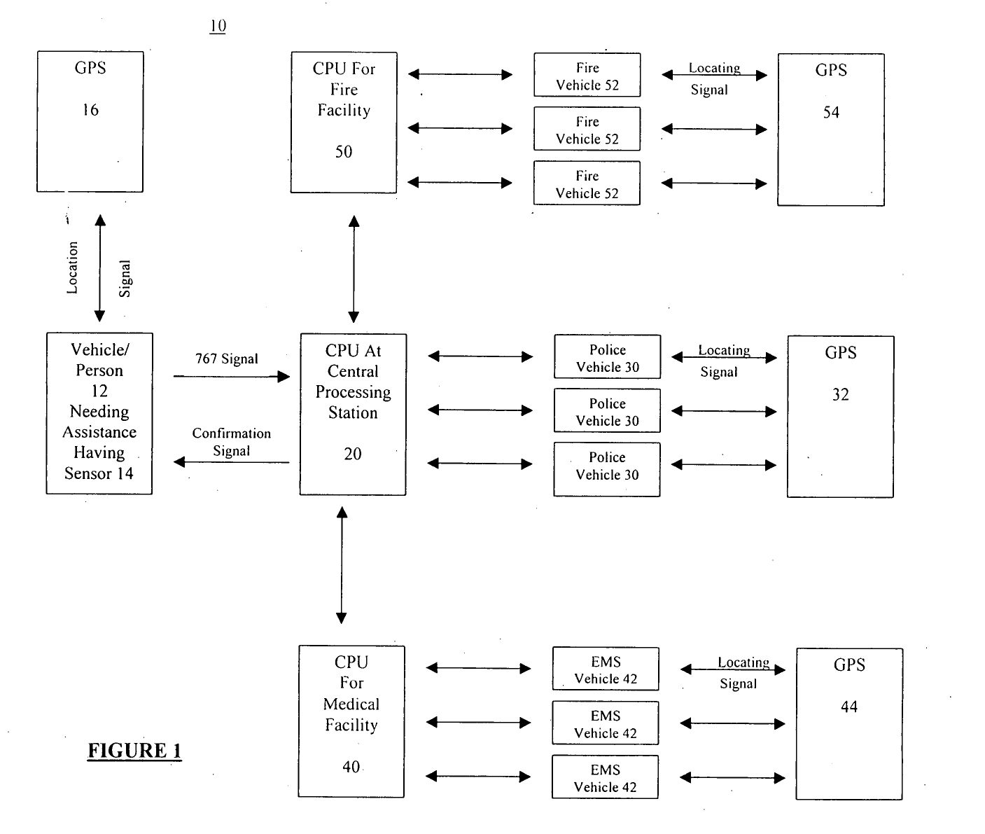

FIG. 1 is schematic block diagram of the present invention. This instantaneous, automatic, mobile phone wireless telecommunications system with an integrated impact (motion) sensor/stand, vehicle-to-vehicle and person-to-vehicle notification system and process, is accomplished by employing the following items to communicate an exigency: existing flawless mobile phone with integrated accident sensing and theft motion sensing devices with micro-processing characterization technologies, e.g., linear displacement sensors, accelerometers, ultrasonic sensors, microwave, optical, and laser sensors, vehicle theft motion sensors having characterization technology as presented in U.S. Pat. RE38,378 that describes a flawless vehicle/aircraft theft deterrence system; a vehicle fleet management system currently used in the market place for mobile positioning and communication with real time location capability, and triage sensors that monitor critical human physiological parameters for medical emergencies. Trimble's Fleetvision 3.0 system or other conventional GPS/FMS require a software system upgrade so that they can receive and then direct a bonafide emergency call to the nearest P/EMS cruiser(s) when an automobile, SUV, commercial vehicle, etc., is in need of time-critical emergency assistance. In this manner, i.e., requesting direct emergency assistance, whether it is from a vehicle or person in need of time-critical assistance, is totally automatic and instantaneous using a dedicated vehicle emergency number.

Conventional GPS/FMS have cellular/global positioning, mobile phones systems, as well as notification and vehicle tracking capability that rely on wireless communications. Nevertheless, some modifications will have to be made to the existing GPS/FMS to satisfy the novel operational aspects of the technology described herein. A novel software program would be added to the GPS/FMS that would now allow this system to automatically identify and screen emergency incoming digital messages. As part of a CPU, central processing unit, or computer, the modified GPS/FMS would analyze the information and confirm the exigency in milliseconds. The CPU then automatically directs the message to the nearest P/EMS cruiser(s) conveying pertinent information from the vehicle or person that is seeking assistance. Again, this would be accomplished automatically and by wireless means from a vehicle or person. For example, if a vehicle accidentally overturns or in another circumstance, is in imminent danger of being violated or stolen, a sensor in the vehicle sends a signal to the communications subsystem of the CPU.

GPS/FMS as a matter of standard operating procedure constantly monitor the geographical position of all of the vehicles in the systems database (fleet). As such, the system is capable of instantly identifying and notifying at least one or two, if available, P/EMS cruiser(s) that are in closest proximity to the vehicle in distress or danger. The information conveyed to the P/EMS cruiser(s) would contain critical information about the vehicle or person location, in distress, such as vehicle color, I.D. Number, owner, etc.

The officer/medical team (OMT), by keeping laptops or mobile phones (open) is automatically recognized by the GPS/FMS as being on duty and available to respond to an emergency call. The OMT operating the cruiser must acknowledge receipt of an incoming emergency message within a predetermined time frame, e.g., within 5 seconds of receipt of the emergency GPS/FMS message. Sending the acknowledgment directly to the CPU having means for processing data from a GPS, FMS and wireless communication devices and not to a dispatcher, will surely save valuable time and lives. Confirmation of the emergency notification by the OMT on duty signifies intent to respond immediately and proceed to the vehicle in distress. Otherwise, the GPS/FMS will automatically route the call to the next closest P/EMS cruiser to respond.

### Operation

FIG. 1 shows the system 10 having a vehicle or person 12 in need of emergency assistance with a sensor 14 and a transmitter, namely the mobile phone system with the impact sensor and/or medical data receiver. The location of the vehicle/person 12 is being monitored by GPS 16 and is supplied to the transmitter. GPS 16 may be an inertial guidance system or equivalent. When an emergency occurs, and is sensed by sensor 14, the transmitter sends a wireless emergency signal to a CPU 20 at a central processing station, such as a police station or other central monitoring station. The emergency signal is coded to identify the type of emergency, such as vehicle accident, vehicle theft, medical emergencies, etc., and also transmits the location data provided by the GPS 16, and identification characteristics of the vehicle 12. The CPU 20 processes the location data from the GPS 16 and uses the FMS to direct the closest vehicle or vehicles to the location of the emergency event.

More specifically, in the case of a vehicle theft or a person in danger, CPU 20 automatically notifies one or more police vehicles 30 to immediately proceed to the location of the emergency event. The police vehicles 30 must notify CPU 20 that they are responding within 5 seconds (or any appropriate interval). If they do not, the CPU 20 notifies the next closest police vehicle 30 to proceed to the location of the emergency event. Once the CPU 20 receives the confirmation signal from the police vehicle(s) 30, the CPU 20 sends a confirmation signal to the vehicle 12 needing assistance that help is on the way. GPS 32 continuously monitors the locations of police vehicles 30 and notifies CPU 20 so that CPU 20 with its FMS capability can process this location data and select the closest vehicles 30 to instantly respond to the location of the emergency event.

In the case of a vehicle accident requiring medical assistance and/or fire assistance, CPU 20 also automatically notifies CPU 40 for the medical facility to immediately dispatch the closest EMS vehicles 42 to the location of the vehicle accident. GPS 44 continuously monitors the locations of EMS vehicles 42 and notifies CPU 40 so that CPU 40 with its FMS capability can process this location data and select the closest EMS vehicle 42 to instantly respond to the location of the emergency event. In the case of a fire, CPU 20 automatically notifies CPU 50 for the fire facility to immediately dispatch the closest fire vehicles 52 to the location of the fire. GPS 54 continuously monitors the locations of fire vehicles 52 and notifies CPU 50 so that CPU 50 with its FMS capability can process this location data and select the closest fire vehicles 54 to instantly respond to the location of the emergency event.

In the case of a person requiring medical assistance, who is not in a vehicle, and is located at home, or in an office, or at a shopping location, then the GPS unit 16 may not be needed. In that case, the person 12 in need of assistance and carrying the mobile phone with the built-in medical monitoring system sends the emergency signal to CPU 20, which automatically provides his or her address or location as to where they are located. As described above, the appropriate vehicles 30, 42 and/or 52 are notified to respond.

The sensors 14 are of the following types depending on the emergency event. When a vehicular accident occurs the mobile phone system with the integrated impact sensor detects the accident therefore sensor 14 in vehicle 12 is activated. The accident sensor 14 activates the transmitter (cell phone line) and it responds to this emergency event by transmitting the emergency signal to CPU 20, as described above.

When a vehicle theft occurs, the mobile phone system with the integrated impact sensor detects the motion sensor 14 in vehicle 12 is activated. The motion sensor 14 senses a predetermined motion signature pattern, which is indicative of a vehicle theft in progress. The motion sensor 14 activates the transmitter and it responds to this emergency event by transmitting the emergency signal to CPU 20, as described above.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

1. A mobile phone communication system with an integrated motion sensor for emergency notification of emergency events,
a) means for sensing an emergency event;
b) means for locating said emergency event;
c) means for transmitting an emergency signal in response to said means for sensing an emergency event and said means for locating said emergency event;

2. A mobile phone communication system with an integrated motion sensor for emergency notification of emergency events,
a) means for sensing an emergency event;
b) means for locating said emergency event;
c) means for transmitting an emergency signal in response to said means for sensing an emergency event and said means for locating said emergency event;
d) a central processing unit (CPU) for receiving said emergency signal;
e) said CPU being located at a central processing station and having a fleet management system (FMS) for monitoring the location of a plurality of emergency vehicles for providing emergency assistance; and

3. A communication system in accordance with claim 2, said CPU further including means for transmitting said emergency signal from said central processing station to a medical CPU for a central medical processing station or to a fire CPU for a central fire station, said medical CPU and said fire CPU each including means for locating and notifying one or more emergency vehicles closest to said emergency event to provide medical assistance or fire assistance.

4. A communication system in accordance with claim 2, further including means for locating and notifying the emergency vehicle next closest to said emergency event if said closest vehicle does not respond in a predetermined time period.

5. A communication system in accordance with claim 2, further including means at said central processing station for sending a confirmation signal to said emergency event confirming that an emergency vehicle is responding to said emergency event.

6. A communication system in accordance with claim 2, wherein said means for transmitting said emergency signal includes a wireless communication device preprogrammed for automatically sending said emergency signal.

7. A communication system in accordance with claim 2, wherein said emergency event is a vehicular accident, and said means for sensing includes a vehicle airbag or other accident sensor, and said emergency signal is coded to indicate a vehicular accident, and said central processing station is a police station and a central medical processing station.

8. A communication system in accordance with claim 2, wherein said emergency event is a vehicle theft, and said means for sensing includes a motion sensor for sensing a predetermined displacement signature pattern, and said emergency signal is coded to indicate a vehicle theft, and said central processing station is a police station.

9. A communication system in accordance with claim 2, wherein said emergency event is a medical emergency, and said means for sensing includes a sensor that monitors vital body signs and detects a medical emergency, and said emergency signal is coded to indicate a medical emergency, and said central processing station is a police station and a central medical processing station.

10. A communication system in accordance with claim 2, wherein said means for locating said emergency event is a GPS (Global Positioning System), or an inertial guidance system.

11. A communication system in accordance with claim 2, wherein said means for transmitting said emergency signal is a wireless communication device.

12. A communication system in accordance with claim 2, wherein said CPU is a computer having means for processing fleet management data, GPS data and data from wireless communication devices.

13. A mobile phone communication system for medical emergency notification of emergency events,
a) means for receiving a medical emergency event;
b) means for locating said emergency event;
c) means for transmitting an emergency signal in response to said means for sensing an emergency event and said means for locating said emergency event;

14. A mobile phone communication system with an integrated motion sensor for emergency notification of emergency to mitigate multi-vehicle collisions when an accident occurs,
a) means for instantly sensing an emergency event;
b) means for locating said emergency event;
c) means for transmitting an emergency signal in response to said means for sensing an emergency event and said means for locating said emergency event;
d) a central processing unit (CPU) for receiving said emergency signal;
e) said CPU being located at a central processing station and having a fleet management system (FMS) for monitoring the location of a plurality of emergency vehicles for providing emergency assistance; and

15. A communication system in accordance with claim 14, said CPU further including means for transmitting said emergency signal from said central processing station to all regional public vehicles.
